(19) United States
(12) Patent Application Publication
(10) Pub. No.: US 2020/0269493 A1
(43) Pub. Date: Aug. 27, 2020

(54) A METHOD FOR MOLD-FREE MANUFACTURING OF NATURAL RUBBER ARTICLES

(71) Applicant: NATIONAL SCIENCE AND TECHNOLOGY DEVELOPMENT AGENCY, Pathumthani (TH)

(72) Inventors: Panithi WIROONPOCHIT, Pathumthani (TH); Sasitorn SRISAWADI, Pathumthani (TH); Sopita DOKKHAN, Pathumthani (TH); Jomkwun MUNNAE, Pathumthani (TH); Sittikorn LAPAPONG, Pathumthani (TH); Surapich LOYKULNANT, Pathumthani (TH); Rattanasuda NAEWNGERNDEE, Pathumthani (TH); Kittaporn UTRA, Pathumthani (TH)

(73) Assignee: NATIONAL SCIENCE AND TECHNOLOGY DEVELOPMENT AGENCY, Pathumthani (TH)

(21) Appl. No.: 16/649,908

(22) PCT Filed: Sep. 7, 2018
(86) PCT No.: PCT/TH2018/000040

§ 371 Date: Mar. 23, 2020

(30) Foreign Application Priority Data
Sep. 28, 2017 (TH) 1701005766
Jun. 1, 2018 (TH) 1801003217
Jun. 1, 2018 (TH) 1801003218

(51) Int. Cl. B29C 64/135; B29B 13/08; C08C 4/00; C08K 3/06; C08K 3/22; C08K 5/39

(52) U.S. Cl. CPC B29C 64/135; B29B 13/08; C08C 4/00; B33Y 10/00; C08K 3/22; C08K 5/39; C08K 3/06

(57) ABSTRACT

This invention relates to the method for mold-free manufacturing of natural rubber articles. Specifically, the articles can be fabricated in the stereolithography process which eliminates the need of mold making and reduces the process time significantly. The method comprises the steps of (1) preparing prevulcanized latex compound for sulfur and non-sulfur vulcanization; (2) adding processing aid to make the latex compound curable when exposed to laser irradiation, the processing aid includes heat-sensitive polymer and/or carbon material(s); and (3) fabricating of three-dimensional rubber articles by stereolithography process. The process are capable of fabricating complex shapes and internal features. As the said rubber articles contain more than 95% of natural rubber, they are highly flexible and can be translucent in some embodiments.

### FIELD OF THE INVENTION

Processes of additive manufacturing relates to a method for mold-free manufacturing of natural rubber articles

### BACKGROUND OF THE INVENTION

Natural rubber is commonly used because of its exceptional mechanical properties. More specifically, its excellent flexibility offers a wide range of application possibilities. Among other natural rubber products in Thailand, rubber gloves have the largest amount of production. In 2013, more than 66,000 tons of natural latex was used in rubber glove production which yielded approximately 1 billion USD (Source: Rubber Authority of Thailand).

Generally, natural rubber is not as strong as other polymeric materials and its physical properties are unstable under temperature change. To improve its mechanical strength and stability, it is necessary to mix the rubber compound with some additives, such as sulfur and accelerators, in the vulcanization and prevulcanization processes. In previous studies, prevulcanized latex were prepared using two methods: (1) sulfur prevulcanization and (2) radiation-initiated prevulcanization which crosslinks the natural rubber chains under the exposure of gamma ray, electron beam, and ultraviolet ray.

The study found that electron beam prevulcanized rubber samples appeared to be dark opaque yellow. The color became as dark as brown when the latex was exposed at a high level of electron beam intensity. The rubber products that are dark in color are usually unattractive because the color is one indicator of toxic chemical residual. Moreover, the products are almost impossible to dye with pigments. According to the invention in Thai patent no. 1601005576, electron beam prevulcanized natural rubber samples appeared to be darker as the latex was exposed at a higher level of electron beam intensity. It is proposed that the deproteinization process can significantly make the appearance of the natural rubber samples lighter and more translucent. Several methods of deproteinization are currently available. US patent no. 20120208938 developed a protein-free natural rubber by adding a urea compound, a surfactant, and a polar organic solvent to the natural latex. U.S. Pat. No. 2,367,120A proposed a process of deproteinizing natural latex which comprises adding an alkali hydroxide, heating, and centrifugal separating. However, the mechanical properties of the deproteinized rubber products are adversely affected.

Most rubber products are fabricated conventionally by extrusion, calendaring, and molding. The mentioned methods rely solely on the molds and dies. Additive manufacturing (AM), commonly known as three-dimensional printing or 3D printing, is an emerging manufacturing technique, in which the material is incrementally formed into a three-dimensional geometries. Without the molds and dies in additive manufacturing, complex geometries can be realized and customized geometries can be integrated into the products without excess costs of mold making. The techniques were initially used for prototype making and progressively shifted into production purposes. As a result, the most critical factors that indicate the potential of additive manufacturing are a list of available types of materials and part quality.

Several types of additive manufacturing for polymer are commercially available, which are categorized based on their types of feedstock and fabrication technologies. The examples of typical additive manufacturing processes for polymer are:
fused deposition modeling (FDM), which extrudes the heated filament through a nozzle that moves in x-y plane to create a layer of material,
selective laser sintering (SLS), which irradiates a beam of laser that provides sufficient energy to selectively sinter a layer of powder, and
stereolithography (SLA), which irradiates a beam of laser that initiates a crosslinking process of the photo-sensitive resin to fabricate a high resolution feature in a short cycle time.

However, most of the additive manufacturing technologies for polymeric material was developed for thermoplastic and thermoset polymer. There are very limited options for elastomeric material.

In U.S. Pat. No. 8,603,612, a curable compositions were used for printing three-dimensional objects. The compositions include a curable monomer, a photoinitiator, a wax, and a gallant. The objects have a room temperature storage modulus from about 0.01 to about 5 GPa. The first and/or second radiation curable monomers can be selected from an acrylic monomer, polybutadiene adducted with maleic anhydride, 3-acryloxypropyltrimethoxysilane, and acryloxypropyl t-structured siloxane. The fabricated objects are in gel-like state which will be heated subsequently.

US patent no. 20160145452 proposed a 3D printable ink comprising up to about 90 wt % monofunctional curable material, up to about 10 wt % difunctional curable material, and up to about 10 wt % liquid rubber, based on the total weight of the ink. In the fabrication process, the ink, which is in fluid state, is selectively deposited layer by layer onto a substrate. Chinese patent no. 105199178A proposed 3D printable photosensitive resin materials comprising modified butadiene rubber which is curable in the stereolithography process. The material containing 10-30 wt % of the modified butadiene rubber, 30-80 wt % of acrylic resin, 10-40 wt % of diluents, 1-2 wt % of initiators and 1-2 wt % of accelerants. The materials proposed in these patents have only small amount of synthetic rubber, thus the 3D printed objects are expected to be less flexible.

US patent no. 20070045891 proposed a composition and method that utilized an additive manufacturing technology, SLS, to produce flexible objects. SLS technology was used to fabricate porous thermosetting objects. The thermosetting resins include epoxies, acrylates, vinyl ethers, and mixtures thereof. In a subsequent process, the SLS objects will be infiltrated with infiltrant comprising an elastomeric material, a vehicle, and an optional colorant. The liquid infiltrant contains about 20-60 wt % of the elastomeric material and prevulcanized natural latex is one option for this process. Then, the objects are dried and, optionally, the steps can be repeated until the objects are infiltrated to a desired degree. Though the final products have rubber composition, this proposed method is not a direct process of fabricating 3D printing rubber objects.

U.S. Pat. No. 9,676,963B2 proposed methods of forming 3D objects from a polymerizable liquid, including a mixture of 1-99 wt % of light polymerizable liquid component and 1-99 wt % of solidifiable component. The light polymerizable liquid component includes monomers, prepolymers, and their mixture. Examples of suitable reactive end groups include, but are not limited to, vinyl esters, maleimides, and vinyl ethers. The light irradiates the build region through the optically transparent member to the polymerizable liquid with reactive end groups. The light initiates the crosslinking process at the solidifiable component and forms solid polymer. This invention solely relies on laser irradiation to reactively crosslink the polymer which is not suitable for natural latex because it is vulnerable to excess energy.

On another hand, natural latex can cause complication in the process of laser irradiation. Generally, natural latex contains a large amount of water which significantly reflects the laser beam. Moreover, natural latex is a colloidal dispersion of rubber particles which scatters the laser beam. Thus, natural latex has low laser absorption which results in the need of high power laser source to provide sufficient power for the fabrication mechanism.

In U.S. Pat. No. 6,916,866, thermoplastic molding compositions were proposed for a better laser absorption properties in the wavelength range from 700 to 1200 nm, so that the transparent/translucent thermoplastic components can be welded by laser beam welding. The material comprises one or more infrared-absorbing compounds and the total composition has a carbon black content of less than 0.1 wt %.

U.S. Pat. No. 6,511,784 and German patent no. 19918363 disclosed methods of using carbon black as absorbers for laser radiation in silicone rubber and recycled polymer, respectively. In U.S. Pat. No. 6,511,784, the absorptivity was improved for laser engraving on silicone rubber plates with thickness between 0.5 to 7 mm. The absorbers include ferrous inorganic solid and/or carbon black. In the example, 10 wt % of carbon black was used in the test of irradiation from Nd-YAG lasers (1064 nm wavelength.) In another example, 15 wt % of carbon black were also mixed with 85 wt % of natural rubber, but the engraving was not successful as the engraved elements showed melt edges and tacky surfaces.

### BRIEF DESCRIPTION OF DRAWING

FIG. 1 shows a step of irradiating onto the layer of the mixture of prevulcanized natural rubber latex and processing aid with laser beam that traces a predetermined cross section of an article

FIG. 2 shows an equipment for stereolithography process in this invention.

### DETAILED DESCRIPTION OF THE INVENTION

This invention relates to the method for mold-free manufacturing of natural rubber articles. The method comprises the steps of (1) preparing prevulcanized natural rubber latex; (2) adding processing aid into the prevulcanized natural rubber latex for obtaining the mixture of prevulcanized natural rubber latex and processing aid; and (3) fabricating the mixture of prevulcanized natural rubber latex and processing aid to three-dimensional natural rubber articles by stereolithography (SLA) process. The process are capable of fabricating complex shapes and internal features.

The method comprises the steps of:

### (1) Preparing Prevulcanized Natural Rubber Latex

Prevulcanization system includes, but not limited to, sulfur prevulcanization system, peroxide prevulcanization system, or irradiation prevulcanization system.

1.1 Sulfur prevulcanization composition includes natural rubber latex, sulfur as a vulcanizing agent, metal oxide, accelerator(s), and antidegradant(s).

The natural rubber latex comprises natural rubber latex which has dry rubber content in the range of 30-60 wt %.

The sulfur prevulcanizing agent can be selected from, but not limited to, sulfur. The metal oxide(s) can be selected from, but not limited to, zinc oxide and magnesium oxide. The accelerator(s) can be selected from, but not limited to, a group of dithiocarbamates, thiurams, and guanidines, where
dithiocarbamate(s) can be selected from zinc dimethyldithiocarbamate, zinc diethyldithiocarbamate, zinc dibenzyldithiocarbamate, and combination thereof,
thiuram(s) can be selected from tetramethyl thiuram monosulphide, tetramethyl thiuram disulphide, tetraethyl thiuram disulphide, and combination thereof, and
guanidine(s) can be selected from diphenyl guanidine, di-o-tolyl guanidine, and combination thereof.

A suitable composition for preparing prevulcanized natural rubber latex in sulfur prevulcanization system, comprising;
a. natural rubber latex,
b. sulfur which is in the range of 0.1-5.0 parts per 100 parts by weight of dry rubber content (phr),
c. zinc oxide which is in the range of 0.1-5.0 phr,
d. accelerator(s) which is in the range of 0.1-3.0 phr, and
e. antidegradant(s) which is in the range of 0.1-5.0 phr.

The sulfur prevulcanization system carries out at temperature of 50-70° C. for 1-5 hours.

1.2 Peroxide prevulcanization composition includes natural rubber latex and peroxide vulcanizing agents. The natural rubber latex comprises natural rubber latex which has dry rubber content in the range of 30-60 wt %. The peroxide vulcanizing agents can be selected from, but not limited to, dicumyl peroxide and benzoyl peroxide.

1.3 Irradiation prevulcanization composition includes natural rubber latex, initiator(s), and coagent(s). The said radiation can be selected from electron beam, gamma ray, ultraviolet wave, infrared wave, microwave, radio wave, and combination thereof.

The natural rubber latex comprises natural rubber latex which has dry rubber content in the range of 30-60 wt %.

The initiator(s) can be selected from, but not limited to, a group of α-hydroxyketone, phenylglyoxylate, α-aminoketone, phosphine oxide, metallocene, benzophenone, and combination thereof, for example;
an α-hydroxyketone can be selected from 1-hydroxycyclohexyl phenyl ketone, 2-hydroxy-2-methyl-1-Phenyl-1-propanone, and combination thereof,
a phenylglyoxylate can be selected from methyl benzoylformate, oxy-phenyl-acetic 2-[2-hydroxy-ethoxy]-ethyl ester, and combination thereof,
an α-aminoketone can be selected from 2-Benzyl-2-(dimethylamino)-1-[4-(4-morpholinyl)phenyl]-1-butanone, 2-Methyl-1-[4-(methylthio)phenyl]-2-(4-morpholinyl)-1-propanone, and combination thereof,
a phosphine oxide can be selected from diphenyl (2,4,6-trimethylbenzoyl)-phosphine oxide, dimethyl (phenyl)-phosphine oxide, butyl(diphenyl)-phosphine oxide, and combination thereof,
a metallocene is selected from the group consisting of titanocene, ferrocene, and zirconocene, and combination thereof.

The coagent(s) can be selected from, but not limited to, a group of mono-functional groups, di-functional groups, tri-functional groups, multi-functional groups, and combination thereof, for example;
a mono-functional group coagent can be selected from normal-butyl acrylate, methyl methacrylate, pheonoxy ethyl acrylate, hydroxyethyl methacrylate, pheonoxy polyethylene glycol acrylate, and combination thereof,
a di-functional group coagent can be selected from 1,9-nonanediol diacrylate, dimethylamino ethyl methacrylate, trimethylene glycol dimethacrylate, and combination thereof,
a tri-functional group coagent can be selected from trimethylol propane triacrylate, trimethylol propane trimethacrylate, triallyl cyanurate, and combination thereof,
a multi-functional group coagent can be selected from tetramethylol methane tetraacrylate, pentaerythritol teraacrylate, and combination thereof.

In addition to the compositions above, there are some necessary substances, but not limited to, such as antidegradant(s), stabilizer(s), filler(s), defoamer(s), and combination thereof.

The antidegradant(s) can be selected from, but not limited to, a group of amine derivatives, phenol derivatives, and combination thereof, for example;
an amine derivative can be selected from N-isopropyl-N′-phenyl-p-phenylenediamine, N-(1,3-dimethylbutyl)-N′-phenyl-p-phenylenediamine, 2,2,4-trimethyl-1,2-dihydroquinoline), and combination thereof,
a phenol derivative can be selected from 2,6-di-tert-butyl-p-cresol, poly(dicyclopentadiene-co-p-cresol), 4,4′-butylidene-bis-(2-tert-arylbutyl-5-methylphenol), and combination thereof.

The stabilizer(s) can be selected from, but not limited to, a group of potassium hydroxide, ammonium hydroxide, fatty acid soap, organic sulphates, organic sulphonate, and combination thereof, for example;
a fatty acid soap can be selected from potassium laurate, potassium oleate, and combination thereof,
an organic sulfates can be selected from sodium lauryl sulfate, potassium dodecyl sulfate, aluminium dodecyl sulfate, and combination thereof.
an organic sulfonate can be selected from sodium dodecyl sulfonate, etc.

The filler(s) can be selected from, but not limited to, calcium carbonate, titanium dioxide, silica, synthetic fibers, natural fiber, and combination thereof.

The defoamer(s) can be selected from, not limited to, a group of silicone (such as silicone glycol, fluorosilicone, etc.) and a group of ethylene oxide and propylene oxide (such as polyethylene glycol, polypropylene glycol, etc.), and combination thereof.

A complete prevulcanization process is indicated by a chloroform number in the range of 3-4 and a swelling index of more than 85%.

(2) Adding Processing Aid into the Prevulcanized Natural Rubber Latex for Obtaining the Mixture of Prevulcanized Natural Rubber Latex and Processing Aid

The processing aid is selected from the group of heat sensitive polymers, carbon materials, and combination thereof.

The step can be selected from one or more of the following:

2.1 adding heat-sensitive polymer to the prevulcanized natural rubber latex so that the mixture has 0.1-5.0 parts of heat-sensitive polymer per 100 parts of dry rubber content. The mixture is mechanically mixed at a temperature of 10-25° C. for 15-60 minutes.

The heat-sensitive polymer can be selected from poly(N-isopropylacrylamide), poly(N-acryloyl glycinamide), poly[2-(dimethylamino)ethyl methacrylate], polyhydroxyethylmethacrylate, polyethylene oxide, hydroxypropylcellulose, poly(vinylcaprolactam), polyvinyl methyl ether, poly(N-vinylimidazole-co-1-vinyl-2-(hydroxymethyl)imidazole), poly (acrylonitrile-co-acrylamide), and combination thereof.

2.2 adding carbon material to the prevulcanized natural rubber latex so that the mixture has 0.5-20.0 parts of carbon material(s) per 100 parts of dry rubber content. The carbon material(s) is selected from, but not limited to, graphite, graphene, carbon black, carbon nanotube, and combination thereof. The said carbon material(s) is in the form of powder or colloidal solution.

The said colloidal solution comprises carbon material(s) and surfactant solution which comprises the following:
solvent(s) which can be selected from water, or a base solution. The said base includes, but not limited to, ammonia, potassium hydroxide, sodium hydroxide, and combination thereof,
surfactant(s) includes, but not limited to, sodium dodecyl sulfate, potassium oleate, polyether, and combination thereof.

The colloidal solution is prepared by adding the surfactant to the solvent so that the mixture has a concentration of 20-40 millimolar. The mixture is mechanically mixed at room temperature for 30-60 minutes. Subsequently, the carbon material is added to the colloidal solution and mixed by ultrasonic stirring for 5-120 minutes. The mixture of carbon black and colloidal solution is later called carbon black slurry.

Next, the addition of carbon slurry into prevulcanized natural rubber latex can be done by mechanical mixing at room temperature for 30-120 minutes.

### (3) Fabricating the Mixture of Prevulcanized Natural Rubber Latex and Processing Aid to Three-Dimensional Natural Rubber Articles by Stereolithography Process

The method can be done in the following steps:

a) a step of creating a 50-500 μm-thick layer of the mixture of prevulcanized natural rubber latex and processing aid on a substrate or a previous layer;

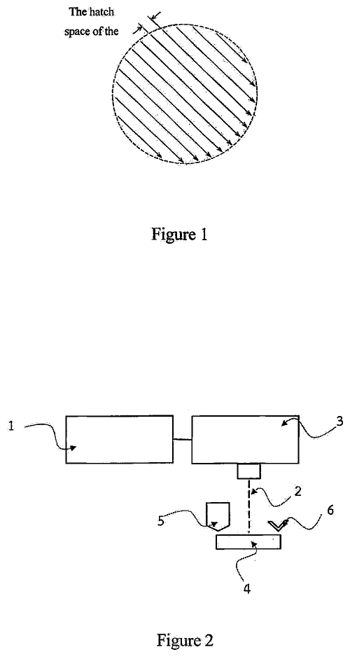

b) a step of irradiating the layer of the mixture of prevulcanized natural rubber latex and processing aid with laser beam that traces a predetermined cross section of an article, as shown in FIG. 1, to form a layer of solid natural rubber where:
the electromagnetic radiation of the laser source can be selected from a radiation wavelength in the ranges of 200-450 nm (ultraviolet range) or 700 nm-1 mm (infrared range),
the pulse frequency of the laser is in the range of 20-100 kHz,
the scan speed of the laser is in the range of 50-200 mm/s,
the hatch space of the laser is in the range of 100-300 μm, and
the power density of the laser in the range of 70-250 W/cm².

c) repeating the a)-b) steps until the three-dimensional article is completed.

The steps of mold-free fabrication of three-dimensional natural rubber articles can also include, but not limited to, the following steps;
a step of cleaning and removing the excess liquid prevulcanized natural rubber latex by spraying or soaking the article with solvents or surfactant solutions; and
a step of drying the article at a temperature of 70-120° C. for 1-4 hours to remove excess moisture and complete the crosslinking process.

The said solvent can be selected from, but not limited to, water, base solution, surfactant solution, and combination thereof.

The said base solution includes ammonia, potassium hydroxide, etc.

The said surfactant solution includes sodium decyl sulfate solution, potassium oleate solution, polyether solution, etc.

### Example

The following is non-limiting examples, which disclose the preparation of representative methods of this present invention.

Natural rubber samples were fabricated in the following steps;

1) Preparing the Prevulcanized Natural Rubber Latex Compound

a) Sulfur Prevulcanization (for Natural Rubber Samples of Formulation 1, 5, and 6)

Ammonia-preserved natural rubber latex was used to prepare the prevulcanized natural rubber latex for stereolithography process which comprises sulfur, one or more of the accelerator(s) from the groups of the thiurams and the dithiocarbamates, an antidegradant, and zinc oxide, as shown in Table 1. The mixture was mechanically mixed at a temperature of 50° C. for 2 hours to maximize an efficiency of chemical reaction in the natural rubber latex. The complete prevulcanization process was indicated by a chloroform number of 3 and a swelling index of approximately 85%. Then, the prevulcanized natural rubber latex was stored at a temperature of 5° C. to terminate the prevulcanization mechanism.

b) Irradiation Prevulcanization (for Natural Rubber Samples of Formulation 2, 3, and 4)

Ammonia-preserved natural rubber latex with 50 wt % dry rubber content was used to prepare the prevulcanized natural rubber latex for stereolithography process which comprises an initiator and a coagent, as shown in Table 1; formulation 2 for the UV curing in and formulation 3 and 4 for the EB curing. The mixture was mechanically mixed at a room temperature for 1 hour to allow all of the chemicals to swell the natural rubber particles before the irradiation time. The natural rubber latex mixture was irradiated under the radiation until the prevulcanization was completed which was indicated by a chloroform number of 3.5 and a swelling index of approximately 95%. Then, the antidegradant was added. The irradiated prevulcanized natural rubber latex is stored at a temperature of 5° C. to terminate the prevulcanization mechanism.

TABLE 1
Composition for preparing the prevulcanized natural rubber latex compound

| Natural | Natural | | | | | | Anti- | Processing |
|---|---|---|---|---|---|---|---|---|
| rubber latex | rubber latex | Sulfur | Accelerator (s) | ZnO | Initiator | Coagent | degradant | aid |
| formulation | (phr) | (phr) | (phr) | (phr) | (phr) | (phr) | (phr) | (phr) |
| 1 | 100 | 1 | 2 | 5 | — | — | 1 | 1.5 |
| 2 | 100 | — | — | — | 1 | 2 | 1.5 | 1.5 |
| 3 | 100 | — | — | — | — | 2 | — | 1.5 |
| 4 | 100 | — | — | — | — | — | — | 1.5 |
| 5 | 100 | 1 | 2 | 5 | — | — | 1 | 7.5 |
| 6 | 100 | 1 | 2 | 5 | — | — | 1 | — |

2) Adding the Processing Aid to the Prevulcanized Natural Latex

One of the processing aid was blended into the prevulcanized natural rubber latex compound in the amount shown in Table 1. The mixture was mechanically mixed at a temperature of 20° C. for 1 hour. The natural rubber latex mixture was diluted with water to obtain 30-60 wt % dry rubber content before use.

3) Fabricating Natural Rubber Articles by an Stereolithography Process or a Conventional Air Dry Process.

a) Stereolithography Process

An equipment for stereolithography process in this invention is shown in FIG. 2. A laser source (1) produces an electromagnetic radiation (2) of which the deflection is controlled by a galvanometer scanner (3) to selectively irradiate the laser beam onto the layer of the prevulcanized natural rubber latex with the processing aid. The layer of the prevulcanized natural rubber latex with the processing aid is fed on a substrate (4) or a previous layer by a material container (5) wherein contains the prevulcanized natural rubber latex with the processing aid. The material container (5), having an opening at the bottom which supplies the prevulcanized natural rubber latex with the processing aid to the substrate (4), is fixed above the top surface of the substrate (4). A layer thickness is adjusted by a layer recoater (6), which is a rectangular metal sheet folded 90 degrees in the direction that is parallel to the long edge of the rectangle. The layer recoater (6) is positioned so that the outer edge of the folded corner faces the top surface of the substrate (4) with a gap size of 100-500 μm. The layer recoater (6) is horizontally moveable from one edge of the substrate (4) to another to adjust the thickness of the layer of the prevulcanized natural rubber latex with the processing aid to be 100-500 μm. The galvanometer scanner (3) selectively irradiates the laser beam onto the layer of the prevulcanized natural rubber latex with the processing aid to form a coagulated area of natural rubber layer. The steps of forming the natural rubber layers are repeated until the three-dimensional articles are completed.

With mold-free fabrication method of three-dimensional natural rubber articles using stereolithography process, the prevulcanized natural rubber latex with the processing aid were fabricated under the electromagnetic radiation wavelength of 300-450 nm (UV laser) or the electromagnetic radiation wavelength of 10,600 nm which gives the energy intensity of 150 Watt/cm². During the irradiation, the prevulcanized natural rubber latex with the processing aid in this area were coagulated.

This example used the laser beam irradiation to trace a predetermined cross section of an article with the following settings:
The applied laser power gives the energy intensity of 150 Watt/cm²;
The applied pulse frequency of the laser irradiation was of 20 kHz;
The applied scan speed of the laser irradiation was of 50 mm/s;
The applied hatch space of the laser irradiation was 100 μm.

A step of cleaning and removing the excess liquid prevulcanized natural rubber latex comprises leaching the article with water and base solution. Then, the article was dried at a temperature of 70° C. for 2 hours to remove excess moisture and complete the crosslinking process. With the steps above, a solid three-dimensional natural rubber article was fabricated from the prevulcanized natural rubber latex with the processing aid.

b) Conventional Air Dry Process

Some prevulcanized natural rubber latex samples with the processing aid (formulation 1, 2, and 5) were prepared by the conventional air dry process for comparison. A glass mold was filled with said prevulcanized natural rubber latex and stored at a room temperature to complete the crosslinking process.

### Sample Preparation and Testing

### Mechanical Properties Testing

The natural rubber samples of formulation 1, 2, and 5 were formed by the methods of (1) stereolithography process and (2) conventional air dry process. The sample thicknesses were controlled to be in the range of 0.30-1.00 mm. A mechanical test was conducted for all of the samples to compare the modulus at 100%, modulus at 300%, and tensile strengths of each sample.

### Physical Properties Testing

Physical properties, such as transparency and the darkness of the natural rubber articles, can be compared by using Haze tester and CIE LAB instrument. Haze test measures the amount of light that is transmitted when passing through a transparent material. The total transmittance is reported. CIE LAB is a color space defined by the International Commission on Illumination (CIE) which uses the concept of the opposite color. It expresses the color as three numerical values, L*, a*, and b*.

L* for the lightness the value shows 0 (dark) to 100 (light)

a* for the green-red color components, with green in the negative direction and red in the positive direction.

b* blue-yellow color components, with blue in the negative direction and yellow in the positive direction.

For all transparency and darkness analysis, the white background is used to prevent the interference from surroundings.

### Result Discussions

The mechanical test is conducted on natural rubber samples of formula 1, 2, and 5. Table 2 shows that the modulus at 100%, modulus at 300%, and tensile strengths of the natural rubber samples from the stereolithography process are slightly different from those of the samples from the conventional process. Thus, it can be concluded that the natural rubber samples of formulation 1, 2, and 5 can be used in the mold-free fabrication process to form the natural rubber latex into a high elasticity and soft articles, when compared to the conventional process.

TABLE 2
Results from mechanical tests of the natural rubber samples

| Natural | | | | |
|---|---|---|---|---|
| rubber | | Modulus | Modulus | Tensile |
| formu- | Process of | at 100% | at 300% | strength |
| lation | fabrication | (MPa) | (MPa) | (MPa) |
| 1 | Stereolithography | 0.69 ± 0.06 | 1.27 ± 0.07 | 17.1 ± 3.69 |
| 1 | Conventional | 0.90 ± 0.04 | 1.62 ± 0.05 | 19.99 ± 1.73 |
| 2 | Stereolithography | 0.35 ± 0.02 | 0.69 ± 0.02 | 15.13 ± 1.13 |
| 2 | Conventional | 0.43 ± 0.02 | 0.81 ± 0.07 | 15.07 ± 0.91 |
| 5 | Stereolithography | 0.67 ± 0.02 | 1.62 ± 0.02 | 18.25 ± 1.69 |
| 5 | Conventional | 0.63 ± 0.04 | 1.45 ± 0.14 | 18.48 ± 1.75 |

The natural rubber samples of formulation 1 and 2 were formed by the stereolithography process and the natural rubber samples of formulation 1 were formed by the conventional process at the thicknesses in the range of 0.10-0.50 mm for the light test. According to the results shown in Table 3, the transmittance percentage of the natural rubber sheet of formulation 2 formed by stereolithography process is higher than that of the natural rubber sheet of formulation 1 formed by stereolithography process and the value of CIE L and CIE b shows that the natural rubber sheet of formulation 2 formed by stereolithography process is the most transparent and lightest. Moreover, the natural rubber samples of formulation 1 were formed by the conventional process was the least transparent and darkest.

TABLE 3
Results from light test showing transparency,
CIE L, and CLE b of the natural rubber samples

| Natural | | | | | |
|---|---|---|---|---|---|
| rubber | | | Light properties | | |
| formu- | Process of | Thickness | Transmittance | | |
| lation | fabrication | (mm) | percentage | CIE L | CIE b |
| 2 | Stereoli- | 0.3 | 72.6 | 87.24 | 18.88 |
| | thography | | | | |
| 1 | Stereoli- | 0.3 | 37.5 | 84.38 | 22.15 |
| | thography | | | | |
| 1 | Conventional | 0.3 | — | 81.07 | 31.51 |

In the process of stereolithography, the natural rubber latex samples of formulation 5 and 6 were irradiated with the laser beam. With the presence a carbon materials in formulation 5, the temperature of the natural rubber latex was increased from 24.9 to 78.5° C. and the material in this area was coagulated. On the other hand, with the absence of a carbon materials in formulation 6, the temperature of the natural rubber latex was increased only 6.4° C. and the heat was not enough to coagulate the material in that area. In conclusion, the presence of carbon materials in the sulfur-prevulcanized natural rubber latex can improve its energy absorption during the stereolithography process.

TABLE 4
Temperature changes of the sulfur-prevulcanized natural rubber
latex with the presence and absence of a carbon material

| Natural | | | | | |
|---|---|---|---|---|---|
| rubber | | Energy | Temperature (° C.) | | |
| formu- | Process of | intensity | Before | During | Appearance |
| lation | fabrication | (watt/cm²) | irradiation | irradiation | of the latex |
| 5 | Stereoli- | 150 | 25 | 78.5 | Coagulated |
| | thography | | | | |
| 6 | Stereoli- | 150 | 24.9 | 31.3 | Not |
| | thography | | | | coagulated |

### BEST MODE

As mentioned in detailed description of the invention.

1-39. (canceled)

40. A method of forming a three-dimensional object, comprising:
(a) preparing prevulcanized natural rubber latex;
(b) adding a processing aid into the prevulcanized natural rubber latex for obtaining the mixture of prevulcanized natural rubber latex and processing aid; and
(c) fabricating the mixture of prevulcanized natural rubber latex and processing aid to three-dimensional rubber articles by a stereolithography (SLA) process.

41. The method of claim 40, wherein preparing prevulcanized natural rubber latex is performed on a composition comprising natural rubber latex which has dry rubber content in the range of 30-60 wt %.

42. The method of claim 40, wherein preparing prevulcanized natural rubber latex is performed on at least one sulfur prevulcanization system, peroxide prevulcanization system, or irradiation prevulcanization system.

43. The method of claim 42, wherein the irradiation prevulcanization system includes at least one electron beam, gamma ray, ultraviolet wave, infrared wave, microwave, radio wave, and combinations thereof.

44. The method of claim 42, wherein the prevulcanized natural rubber latex in the sulfur prevulcanization system comprises natural rubber latex, sulfur, zinc oxide, accelerators, and antidegradants.

45. The method of claim 44, wherein said composition, comprises:
natural rubber latex;
b. sulfur in the range of 0.1-5.0 parts per 100 parts by weight of dry rubber content (phr);
c. zinc oxide in the range of 0.1-5.0 phr;
d. at least one accelerator in the range of 0.1-3.0 phr; and
e. at least one antidegradant in the range of 0.1-5.0 phr.

46. The method of claim 45, wherein the at least one accelerator is selected from the group consisting of dithiocarbamates, thiurams, guanidines, and combinations thereof.

47. The method of claim 46, wherein the dithiocarbamate is selected from the group consisting of zinc dimethyldithiocarbamate, zinc diethyldithiocarbamate, zinc dibenzyldithiocarbamate, and combinations thereof.

48. The method of claim 46, wherein the thiuram is selected from the group consisting of tetramethyl thiuram monosulphide, tetramethyl thiuram disulphide, tetraethyl thiuram disulphide, and combinations thereof.

49. The method of claim 46, wherein the guanidine is selected from the group consisting of diphenyl guanidine, di-o-tolyl guanidine, and combination thereof.

50. The method of claim 42, wherein the sulfur prevulcanization system is held at temperature ranging from 50-70° C. for 1-5 hours.

51. The method of claim 43, wherein preparing the prevulcanized natural rubber latex in the irradiation prevulcanization system via ultraviolet wave includes a composition comprising:
a. natural rubber latex;
b. at least one initiator in the range of 0.1-5.0 parts per 100 parts by weight of dry rubber content (phr);
c. at last one coagent in the range of 0.1-5.0 phr; and
d. at least one antidegradant in the range of 0.1-5.0 phr.

52. The method of claim 51, wherein the at least one initiator is selected from the group consisting of α-hydroxyketone, phenylglyoxylate, α-aminoketone, phosphine oxide, metallocene, benzophenone, and combinations thereof.

53. The method of claim 52, wherein said α-hydroxyketone is selected from the group consisting of 2-hydroxy-2-methyl-1-phenyl-1-propanone, 1-hydroxycyclohexyl phenyl ketone, and combinations thereof.

54. The method of claim 52, wherein said phenylglyoxylate is selected from the group consisting of methyl benzoylformate, oxy-phenyl-acetic 2-[2-hydroxy-ethoxy]-ethyl ester, and combinations thereof.

55. The method of claim 52, wherein said α-aminoketone is selected from the group consisting of 2-benzyl-2-(dimethylamino)-1-[4-(4-morpholinyl)phenyl]-1-butanone, 2-methyl-1-[4-(methylthio)phenyl]-2-(4-morpholinyl)-1-propanone, and combinations thereof.

56. The method of claim 52, wherein said phosphine oxide(s) is selected from the group consisting of diphenyl (2,4,6-trimethylbenzoyl)-phosphine oxide, dimethyl (phenyl)-phosphine oxide, butyl(diphenyl)-phosphine oxide, and combinations thereof.

57. The method of claim 52, wherein said metallocene is selected from the group consisting of titanocenes, ferrocenes, zirconocenes, and combinations thereof.

58. The method of claim 51, wherein the at least one coagent is selected from the group consisting of mono-functional groups, di-functional groups, tri-functional groups, multi-functional groups, and combinations thereof.

59. The method of claim 58, wherein said mono-functional groups are selected from the group consisting of normal-butyl acrylate, methyl methacrylate, pheonoxy ethyl acrylate, hydroxyethyl methacrylate, pheonoxy polyethylene glycol acrylate, and combinations thereof.

60. The method of claim 58, wherein said di-functional groups are selected from the group consisting of 1,9-nonanediol diacrylate, dimethylamino ethyl methacrylate, trimethylene glycol dimethacrylate, and combinations thereof.

61. The method of claim 58, wherein said tri-functional groups are selected from the group consisting of trimethylol propane triacrylate, trimethylol propane trimethacrylate, triallyl cyanurate, and combinations thereof.

61. The method of claim 58, wherein said multi-functional groups are selected from the group consisting of tetramethylol methane tetraacrylate, pentaerythritol teraacrylate, and combinations thereof.

62. The method of claim 51, wherein the at least one antidegradant is selected from the group consisting of amine derivatives, phenol derivatives, and combinations thereof.

63. The method of claim 62, wherein the amine derivatives are selected from the group consisting of N-isopropyl-N′-phenyl-p-phenylenediamine, N-(1,3-dimethylbutyl)-N′-phenyl-p-phenylenediamine, 2,2,4-trimethyl-1,2-dihydroquinoline, and combinations thereof.

64. The method of claim 62, wherein the phenol derivatives are selected from the group consisting of 2,6-di-tert-butyl-p-cresol, poly(dicyclopentadiene-co-p-cresol), 4,4′-butylidene-bis-(2-tert-arylbutyl-5-methylphenol), and combinations thereof.

65. The method of claim 40, wherein said processing aid is selected from the group consisting of heat sensitive polymers, carbon materials, and combinations thereof.

66. The method of claim 65, wherein said heat sensitive polymers are selected from the group consisting of a poly(N-isopropylacrylamide), poly(N-acryloyl glycinamide), poly[2-(dimethylamino)ethyl methacrylate], polyhydroxyethylmethacrylate, polyethylene oxide, hydroxypropylcellulose, poly(vinylcaprolactam), polyvinyl methyl ether, poly(N-vinylimidazole-co-1-vinyl-2-(hydroxymethyl)imidazole), poly (acrylonitrile-co-acrylamide), and combinations thereof.

67. The method of claim 65, wherein an amount of said heat sensitive polymers are in the range of 0.1-5.0 parts per 100 parts by weight of dry rubber content.

68. The method of any one of claim 65, wherein said heat sensitive polymers are mixed into the prevulcanized natural rubber latex at a temperature ranging from 10-25° C. for 15-60 minutes.

69. The method of claim 65, wherein said carbon materials are selected from the group consisting of graphite, graphene, carbon black, carbon nanotube, and combinations thereof.

70. The method of claim 65, wherein an amount of said carbon materials are in the range of 0.5-20.0 parts per 100 parts by weight of dry rubber content.

71. The method of any one of claim 65, wherein said carbon materials are in the form of powder or colloidal solution.

72. The method of claim 40, wherein said prevulcanized natural rubber latex having a chloroform number in the range of 3-4 and/or a swelling index of more than 85%.

73. The method of claim 40, wherein said fabricating of three-dimensional rubber articles of stereolithography (SLA) process comprises:
(i) creating a 50-500 μm thick layer of the mixture of prevulcanized natural rubber latex and processing aid on a substrate or a previous layer;
(ii) irradiating the layer of the mixture of prevulcanized natural rubber latex and processing aid with a laser beam; and
(iii) repeating steps i)-ii) until the three-dimensional article is completed.

74. The method of claim 73, wherein the laser beam has a wavelength in the range of 200-450 nm or 700 nm-1 mm.

75. The method of claim 73, wherein said irradiating has at least one laser parameter selected from a:
(i) pulse frequency in the range of 20-100 kHz;
(ii) scan speed in the range of 50-200 mm/s;
(iii) hatch space in the range of 100-300 μm; and
(iv) power density in the range of 70-250 W/cm².

76. The method of any one of claim 40, further comprising a step of cleaning and removing the excess liquid prevulcanized natural rubber latex in three-dimensional rubber articles by spraying or soaking the article with solvents or surfactant solutions.

77. The method of any one of claim 40, further comprising the step of drying the three-dimensional article at a temperature ranging from 70-120° C. for 1-4 hours.
